(19) United States
(12) Patent Application Publication
(10) Pub. No.: US 2026/0368267 A1
(43) Pub. Date: Nov. 19, 2026

(54) AGENTIC OPEN SOURCE INTELLIGENCE (OSINT)

(71) Applicant: Infoblox Inc., Santa Clara, CA (US)

(72) Inventor: Jeffrey James Sims, Quebec (CA)

(21) Appl. No.: 19/409,188

(22) Filed: Dec. 4, 2025

Related U.S. Application Data
(60) Provisional application No. 63/806,578, filed on May 15, 2025.

(51) Int. Cl. G06F 16/9532; G06F 16/9535

(52) U.S. Cl. CPC G06F 16/9532; G06F 16/9535

(57) ABSTRACT

In some embodiments, a system, a process, and/or a computer program product for OSINT includes generating a plurality of search queries based on a predefined intelligence goal using a query planning agent, in which the predefined intelligence goal is related to OSINT; generating new search queries through a crossover operation and a mutation operation on one or more of the plurality of search queries using a genetic algorithm agent (e.g., the genetic algorithm agent can be further configured to perform the following: evaluate a performance of the search queries based on a predefined fitness criteria; and select high-performing search queries using a tournament selection process); and executing web searches using the generated or optimized search queries using an auto-browser agent for agentic OSINT collection (e.g., the auto-browser agent can be further configured to perform the following: navigate to relevant web pages; and capture text and images content from web pages).

### CROSS REFERENCE TO OTHER APPLICATIONS

This application claims priority to U.S. Provisional Patent Application No. 63/806,578 entitled AGENTIC OPEN SOURCE INTELLIGENCE (OSINT) filed May 15, 2025, which is incorporated herein by reference for all purposes.

### BACKGROUND OF THE INVENTION

Open source intelligence (OSINT) generally refers to the collection and analysis of publicly available data from open/publicly available sources, such as social media, news outlets, public records, and online forums to generate actionable insights. OSINT has become critical in certain fields including cybersecurity.

In cybersecurity, OSINT is often used to identify threats, monitor adversarial activities, and assess vulnerabilities. The proliferation of digital platforms has exponentially increased the volume, velocity, and variety of open source data, enabled real-time threat detection but also introduced significant technical challenges. These technical challenges include efficiently aggregating heterogeneous data formats, ensuring data authenticity, and extracting relevant signals from vast, noisy datasets.

### BRIEF DESCRIPTION OF THE DRAWINGS

Various embodiments of the invention are disclosed in the following detailed description and the accompanying drawings.

FIG. 1 illustrates an overall architecture and workflow for providing an agentic OSINT solution in accordance with some embodiments.

FIG. 2 is a screenshot of a prompt to a Large-Language Model (LLM) for a predefined goal for the agentic OSINT solution in accordance with some embodiments.

FIG. 3 is a screenshot of a prompt to an LLM for goal deconstruction into web queries for the agentic OSINT solution in accordance with some embodiments.

FIG. 4 is a screenshot of a prompt to an LLM for analyzing the performance of a Genetic Algorithm and opting for continuing with exploitation mode for the agentic OSINT solution in accordance with some embodiments.

FIG. 5 illustrates an architecture and workflow for the Genetic Algorithm for the agentic OSINT in accordance with some embodiments.

FIG. 6 illustrates an example of agent derived search terms visualized by a fitness score in accordance with some embodiments.

FIG. 7 is a screenshot of a prompt to an LLM for a Mutation Auto Browser Agent for the agentic OSINT solution in accordance with some embodiments.

FIG. 8 is a screenshot of an AutoBrowser class web search in accordance with some embodiments.

FIG. 9 is a screenshot of an AutoBrowser class scrolling large content with Optical Character Recognition (OCR) chunking capture in accordance with some embodiments.

FIG. 10 is a screenshot of an example markdown report with extracted IOCs, actor, and campaign automatically generated using the agentic OSINT solution in accordance with some embodiments.

FIG. 11 is a flow diagram of a process for agentic OSINT in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Open source intelligence (OSINT) generally refers to the collection and analysis of publicly available data from open/publicly available sources, such as social media, news outlets, public records, and online forums to generate actionable insights. OSINT has become critical in certain fields including cybersecurity.

In cybersecurity, OSINT is often used to identify threats, monitor adversarial activities, and assess vulnerabilities. The proliferation of digital platforms has exponentially increased the volume, velocity, and variety of open source data, enabled real-time threat detection but also introduced significant technical challenges. These technical challenges include efficiently aggregating heterogeneous data formats, ensuring data authenticity, and extracting relevant signals from vast, noisy datasets.

Also, various technical difficulties in OSINT collection and processing stem from the unstructured and dynamic nature of open source data. For example, data sources often vary in format, ranging from text and images to videos and geolocation metadata, requiring sophisticated parsing and normalization techniques. Additionally, the high volume of data necessitates scalable storage and processing systems, often leveraging distributed computing frameworks. Verifying the credibility of sources and detecting manipulated or misleading information, such as deepfakes or disinformation campaigns, poses further complexity.

Existing approaches struggle to balance real-time processing demands with the computational overhead of advanced analytics, such as natural language processing (NLP) and machine learning (ML), which are often used for identifying patterns and anomalies in large datasets.

Moreover, as digital threats accelerate in both volume and complexity, and AI-enabled threat actor development continues to evolve, such trends will likely further deepen this existing asymmetry, in which human analysts (e.g., human malware/security analysts) often struggle to effectively and efficiently synthesize the ever growing volume of intelligence in a timely manner.

As such, existing approaches for OSINT investigation often rely on manual report synthesis (e.g., locating, reading, operationalizing), which is labor intensive and cannot easily scale to meet rapidly evolving threats (e.g., computer/network security related threats).

In addition, the industry-wide surge in agent-based conversations (e.g., artificial intelligence (AI) related agents) has left some defenders feeling empowered and others feeling disillusioned by the hype cycle.

However, autonomous workflows will likely introduce a significant transformation in how adversaries and defenders engage in the age-old cybersecurity game of cat and mouse.

Accordingly, new and improved techniques for agentic OSINT are disclosed as will be further described below.

In some embodiments, a system, a process, and/or a computer program product for agentic OSINT includes generating a plurality of search queries based on a predefined intelligence goal using a query planning agent, in which the predefined intelligence goal is related to OSINT; generating new search queries through a crossover operation and a mutation operation on one or more of the plurality of search queries using a genetic algorithm agent (e.g., the genetic algorithm agent can be further configured to perform the following: evaluate a performance of the search queries based on a predefined fitness criteria; and select high-performing search queries using a tournament selection process); and executing web searches using the generated or optimized search queries using an auto-browser agent for agentic OSINT collection (e.g., the auto-browser agent can be further configured to perform the following: navigate to relevant web pages; and capture content from the web pages, including, for example, text and images).

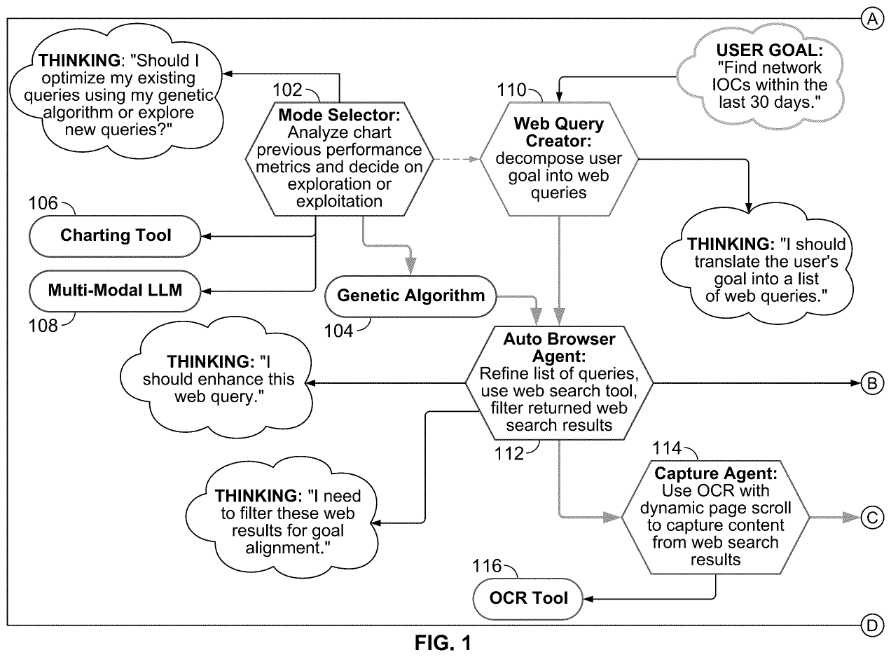

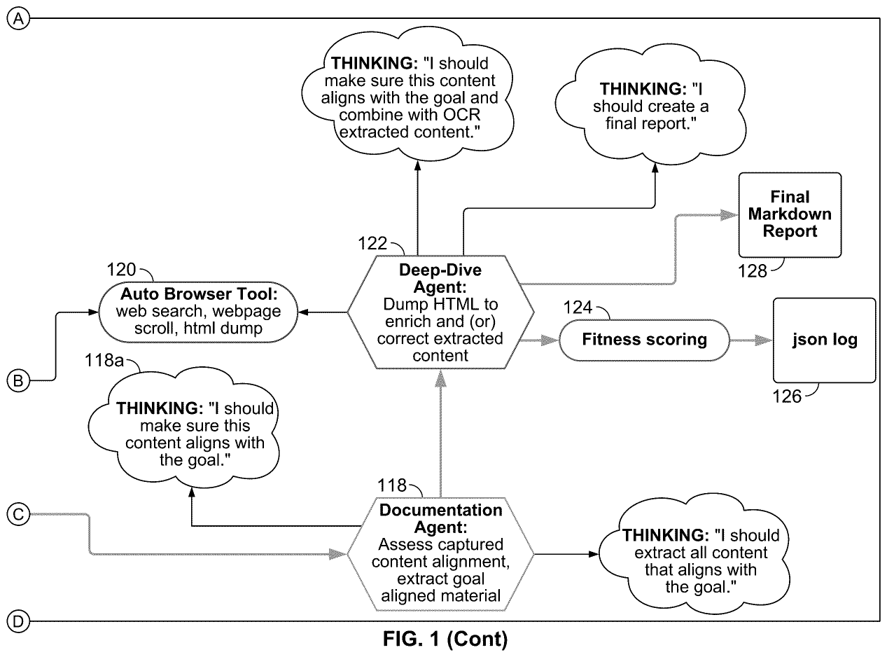

For example, each of the agents can be implemented using one or more Large-Language Models (LLMs), such as shown at 108 in FIG. 1, with distinct prompts, and wherein the executed web searches generate results that include indicators of compromise (IOCs) and associated threat intelligence for collecting OSINT. Examples of additional agents that can be used for implementing the disclosed agentic OSINT solution include the following: an optical character recognition (OCR) agent configured to extract text from captured images; a documentation agent configured to filter extracted content based on relevance to a predefined intelligence goal; and a deep dive agent, such as shown at 122 in FIG. 1, configured to analyze the filtered content and generate a report containing IOCs and associated threat intelligence for collected OSINT.

In some embodiments, a system, a process, and/or a computer program product for agentic OSINT further includes monitoring performance metrics of the system, including IOC discovery rates and fitness scores; and determining whether to operate in an exploration mode or an exploitation mode based on predetermined performance metrics (e.g., in the exploration mode, the query planning agent generates diverse search queries based on the predefined intelligence goal, and in the exploitation mode, the genetic algorithm agent optimizes search queries).

In an example implementation, the genetic algorithm agent is further configured to calculate a fitness score for each search query based on at least one of: a number of search results obtained, a presence of IOCs in the search results, and a relevance of the search results to the predefined intelligence goal.

In some embodiments, in a system, a process, and/or a computer program product for agentic OSINT, the genetic algorithm agent is further configured to perform a tournament selection process that comprises: randomly selecting subsets of search queries; comparing the fitness scores of the search queries in each subset; selecting the search query with a highest fitness score from each subset to proceed to a next stage; and repeating the selection process until a predetermined number of high-performing search queries are selected.

In an example implementation, the mutation operation comprises selecting two parent search queries from high-performing search queries; and combining elements of the two parent search queries to generate a new search query.

In an example implementation, the crossover operation comprises applying natural language transformations to a search query, including at least one of: rearranging words, substituting synonyms, modifying word forms, and increasing a number of words in the search query.

In some embodiments, in a system, a process, and/or a computer program product for agentic OSINT, the auto-browser agent is further configured to: capture screenshots of web pages; scroll through web pages to capture content beyond an initial viewport; and handle portable document format (PDF) documents by attempting direct download and text extraction, and if unsuccessful, loading the PDF in a browser and applying OCR.

In some embodiments, a system, a process, and/or a computer program product for agentic OSINT further includes an OCR agent, in which the OCR agent is configured to process a plurality of screenshots captured by the auto-browser agent and extract text from each screenshot to reconstruct content of a web page.

In some embodiments, a system, a process, and/or a computer program product for agentic OSINT further includes a documentation agent, such as shown at 118 in FIG. 1, in which the documentation agent is configured to: receive extracted text from an optical character recognition (OCR) agent and the auto-browser agent; evaluate the extracted text for relevance to the predefined intelligence goal; and discard segments of text that do not meet a relevance threshold.

In some embodiments, a system, a process, and/or a computer program product for agentic OSINT further includes a deep dive agent, in which the deep dive agent is configured to: parse filtered content to identify indicators of compromise (IOCs), including at least one of the following: IP addresses, domain names, URLs, and file hashes; associate the identified IOCs with threat actors and campaigns if available; and generate a report (e.g., a markdown-formatted report) summarizing results of collected OSINT.

In some embodiments, a system, a process, and/or a computer program product for agentic OSINT further includes a fitness agent, in which the fitness agent is configured to perform a fitness scoring function (e.g., the fitness agent can be implemented using one or more LLMs and another distinct prompt).

These and other embodiments for agentic OSINT will be further described below.

### Multi-Agent Environment for OSINT

In an example implementation, an agentic OSINT platform aims to alleviate manual collection and synthesis pressures by intelligently searching the web, ingesting threat reports, extracting the most salient data to support predefined OSINT goals/objectives, and automatically and dynamically adapting its search strategies. The disclosed multi-agent solution can be implemented using commercially available agents (e.g., using OpenAI's agents software development kit (SDK) or another commercially available AI-based agents can similarly be used), commercially available foundational/large-language models (LLMs) (e.g., one or more commercially available LLMs can be used, such as from Anthropic including their Claude model, Google including their Gemini model, OpenAI including their o3 mini and 4.1 models, etc.), commercially available web browser orchestration (e.g., Playwright browser orchestration or another commercially available web browser orchestration solution can similarly be used), commercially available optical character recognition (OCR), and a genetic algorithm as will be further described below (e.g., based on biological principles of fitness for evolution).

Specifically, the disclosed multi-agent solution determines its mode of operation by plotting and reviewing key performance metrics in real-time, which it interprets to decide if it should explore new search terms for discovery or exploit previously successful queries through its use of the genetic algorithm. This evolutionary learning process represents a significant improvement in autonomous threat intelligence research, providing for enhanced information gathering while balancing expansive exploration with focused exploitation of verified techniques.

Also, the disclosed multi-agent solution can be implemented at scale while delivering targeted insights tailored to strategic objectives and broader cybersecurity goals, such as will be further described below.

FIG. 1 illustrates an overall architecture and workflow for providing an agentic OSINT solution in accordance with some embodiments. The disclosed agentic OSINT solution can be implemented as a system or a service (e.g., Software as a Service (SaaS) solution or other on-premises (on-prem), cloud-based, and/or hybrid on-prem/cloud-based service implementation/offering), etc.

As shown in FIG. 1, the disclosed agentic/multi-agent OSINT solution incorporates a multi-agent environment, but not in the typical sense where each agent has full autonomy in a strictly hierarchical or decentralized setup. Instead, the disclosed agentic/multi-agent OSINT solution both leverages and constrains the probabilistic reasoning and acting (ReAct) paradigm, capturing the best of both technical techniques: repeatable outcomes where consistency is desired, and agentic decision-making where adaptability is most beneficial. This constraint is reflected in the disclosed agentic OSINT architecture as a clearly defined pipeline, with specific ‘forks in the road’ where agentic decision-making comes into play, such as determining an operational mode based on performance evaluations (e.g., explore vs exploit, such as using the Genetic Algorithm as shown in FIG. 1 and as further described below). Further autonomy is harnessed within various sub-processes in the disclosed pipeline, for instance, refining search queries based on active web search observations or filtering web results to maintain goal alignment and avoid overburdening subsequent investigative operations.

Lastly, it is not obligatory for every agent to have a broad range of tools to contribute significant value to the disclosed system/service. Instead, we find that a well-defined tool scope and compartmentalized agentic sub-components preserve a high degree of task-specific creativity, while also producing predictable results that are both easier to troubleshoot and more suitable for commercial production environments. Some of the agents within the disclosed agentic/multi-agent OSINT solution operate without external tools, instead utilizing the SDK's agent class for iterative reasoning cycles, fostering more refined outputs compared to just prompting an LLM for an outcome.

### Operational Modalities and Adaptive Intelligence

The disclosed agentic/multi-agent OSINT solution represents a significant advancement in automated OSINT collection. At its core, the system implements a novel dual-mode operational framework that dynamically balances between exploration and exploitation strategies to optimize search effectiveness. This approach addresses a fundamental challenge in automated research systems: efficiently navigating the trade-off between discovering new information spaces and refining known productive pathways.

The output of the disclosed agentic OSINT system/service is to generate a Final Markdown Report, such as shown at 128 in FIG. 1, based on the refined and executed search queries for actionable and timely OSINT based on the input of the predefined goal (e.g., “Find network IOCs within the last 30 days” as shown in FIG. 1). An example Final Markdown Report is discussed further below.

In an example implementation, example Agent definitions for IOC Research Agent are provided in Appendix-1, and example configuration settings for the IOC Research Agent are provided in Appendix-2.

Each of the agents (e.g., LLM agents) and their prompting, the Genetic Algorithm (104), Auto Browser Agent (112), Auto Browser Tool (120), Fitness scoring (124), and other components of FIG. 1 will be further described below.

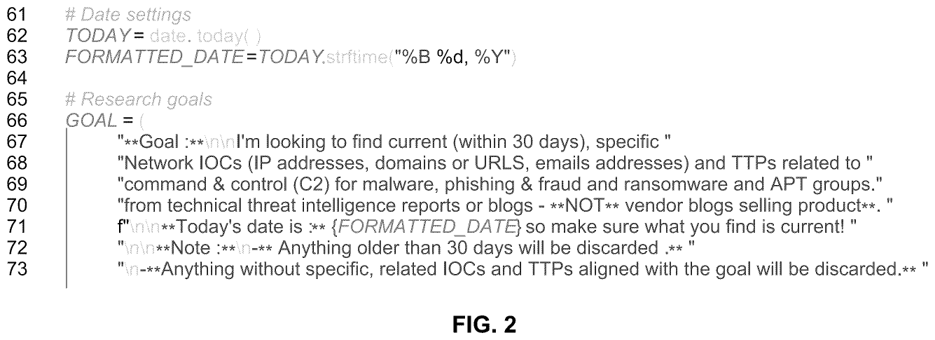

FIG. 2 is a screenshot of a prompt to a Large-Language Model (LLM) for a predefined goal for the agentic OSINT solution in accordance with some embodiments.

Specifically, the example prompt shown in FIG. 2 can be provided as a predefined goal for the Web Query Creator component as shown at 110 in FIG. 1.

In an example implementation, the Mode Selector Agent 102 as shown in FIG. 1 chooses operation between two distinct modes: Goal-Based Generation (e.g., exploration) and Genetic Algorithm (e.g., exploitation) as shown at 104 in FIG. 1. In Goal-Based Generation mode, the disclosed agentic OSINT system/service emphasizes diversity and breadth in search strategies, generating semantically varied queries based on a predefined goal, to explore the information landscape. This mode is characterized by its ability to break free from local optima and discover entirely new regions of the threat intelligence space that may include valuable IOCs.

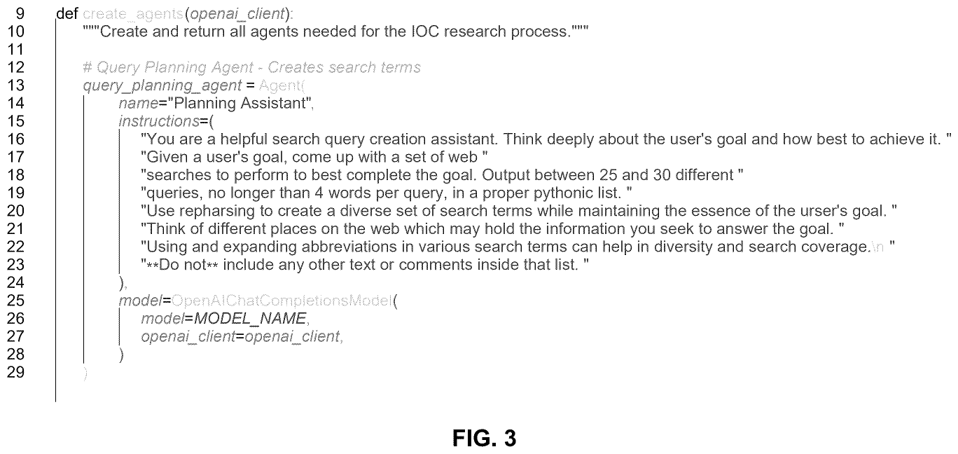

FIG. 3 is a screenshot of a prompt to an LLM for goal deconstruction into web queries for the agentic OSINT solution in accordance with some embodiments.

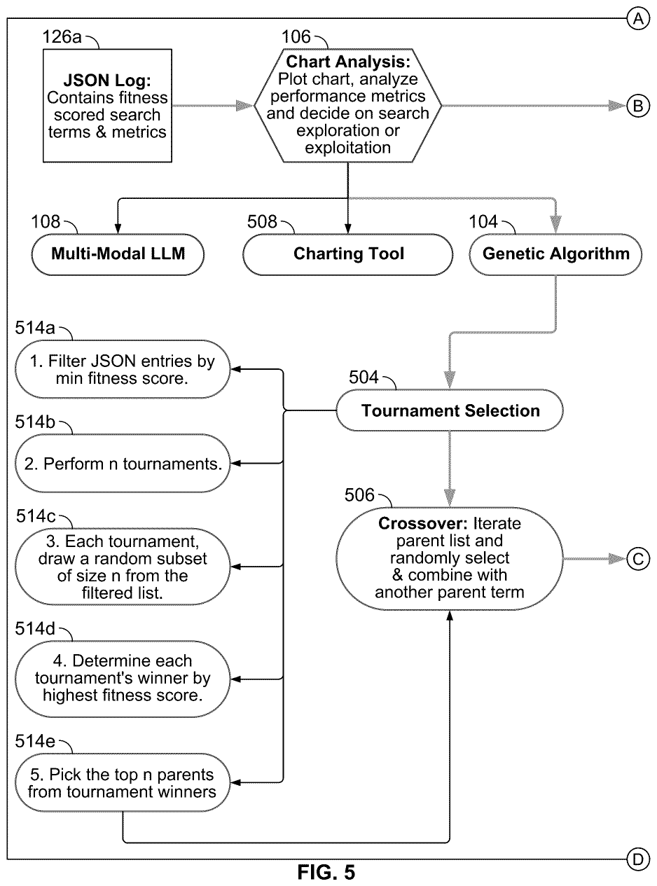

Specifically, the example prompt shown in FIG. 3 can be provided for goal deconstruction into web queries for the Query Planning Agent that is part of the Web Query Creator component as shown in FIG. 1 and shown as the Web Query Planner component as shown at 510 in FIG. 5.

At the heart of the Goal-Based Generation (exploration) mode is the Query Planning Agent, a module of the Web Query Planner component 510 that transforms a user's goal into a set of brief, targeted web queries (e.g., 25 to 30, each under four words, or another targeted number and/or length of web queries can be generated). By leveraging the Agent class's innate reasoning, the Query Planner systematically rephrases, refines, and diversifies these goal-based queries, achieving exploratory coverage across the desired information space (e.g., for OSINT collection based on the predefined goal).

### Genetic Algorithm

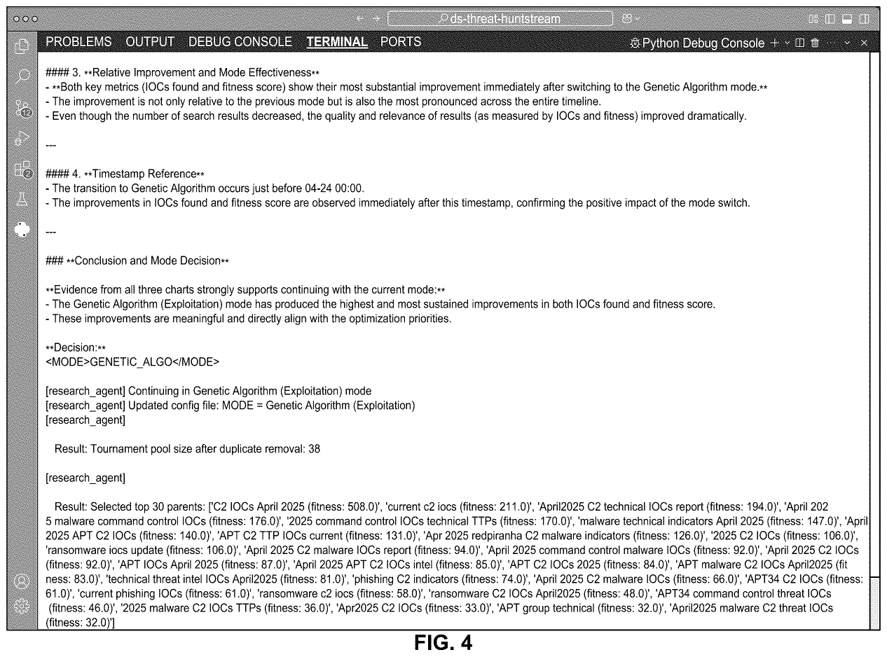

FIG. 4 is a screenshot of a prompt to an LLM for analyzing the performance of a Genetic Algorithm and opting for continuing with exploitation mode for the agentic OSINT solution in accordance with some embodiments. An example implementation of the Genetic Algorithm for web queries for OSINT will be further described below.

Conversely, the Genetic Algorithm mode implements evolutionary selection principles to refine and optimize search terms that have demonstrated effectiveness. This exploitation-focused approach leverages fitness scoring based on IOC yield and search metrics, iteratively evolving search queries through selection, crossover, and mutation operations to maximize information extraction from productive terms (e.g., the Genetic Algorithm is further described below). The fitness score analysis and results can be captured in a log (e.g., a JSON log), such as shown at 126 in FIG. 1.

A distinguishing attribute is the disclosed agentic OSINT solution's capacity for self-optimization through autonomous mode selection. By continuously analyzing performance metrics (e.g., including IOC discovery rates, fitness scores, and search result patterns), the disclosed agentic OSINT system/service employs a trend analysis mechanism to determine when to switch between exploration and exploitation. When the agent detects diminishing returns in the current mode, it will choose to switch modes. If the Mode Selector Agent sees that it is performing optimally, it will continue with the current mode until the performance has exhausted.

FIG. 5 illustrates an architecture and workflow for the Genetic Algorithm for the agentic OSINT in accordance with some embodiments.

An example execution of the disclosed agentic OSINT system/service will now be described with respect to FIGS. 1 and 5.

At a first stage of processing, a class (e.g., a ResearchOrchestrator class) with the agents and configuration is initialized.

At a second stage of processing, an operation to prepare a report is initiated (e.g., Final Markdown Report, such as shown at 128 in FIG. 1).

At a third stage of processing, log data (e.g., a JSON log) is loaded, such as shown at 126a in FIG. 5. The JSON log can include fitness scored search terms and metrics.

At a fourth stage of processing, shown at 106 of FIG. 5, a mode selection is determined. If a manual mode is set, the a predefined mode is utilized. If data points are greater than fifteen, then a trend analysis is performed, which can include generating visualization charts using, for example, visualize trend lines and/or visualize word cloud operations. Also, the charts can be analyzed, for example, using an LLM vision analyzer to determine the mode, such as shown at 108 and 508 in FIG. 5. Otherwise, a default mode is utilized.

At a fifth stage of processing, shown at 104 of FIG. 5, execution proceeds based on the selected mode. If the selected mode is the Genetic Algorithm, as shown at 104, then the following operations are performed.

At a sixth stage of processing, the configuration is updated with the current mode.

At a seventh stage of processing search terms are generated using the Genetic Algorithm to select the top terms from the Tournament Selection processing as shown at 504 of FIG. 5. The JSON entries can be filtered using a minimum fitness score. The fitness data can then be loaded from the JSON log (e.g., JSON Log 126a as shown in FIG. 5).

As shown at 514a in FIG. 5, the JSON entries are filtered by a minimum fitness score. Specifically, in this example implementation, the fitness data is loaded from the JSON log (e.g., JSON Log 126a as shown in FIG. 5). Minimum fitness thresholds are applied to filter the entries.

As shown at 514b in FIG. 5, n tournaments are performed. Specifically, in this example implementation, the number of tournaments to execute/run is set. The tournaments winners list is then initialized.

As shown at 514c in FIG. 5, for each tournament, a random subset of size n from the filtered list is drawn. Specifically, in this example implementation, n entries are randomly selected from the filtered population. A tournament pool is then created.

As shown at 514d in FIG. 5, each tournament's winner is determined based on a highest fitness score. Specifically, in this example implementation, fitness scores of all entries in each tournament pool are compared. An entry with a maximum fitness score is then selected.

At 514e in FIG. 5, the top n parents is selected from the tournament winners. Specifically, in this example implementation, all tournament winners are collected. The top n performers are then selected as parent terms.

Referring now to 506 in FIG. 5, a crossover operation is performed to iterate the parent list and to randomly select and combine with another parent term. Specifically, in this example implementation, for each parent term, another parent term is randomly selected from the list. The terms are then combined to generate a new search term. The combined term is then added to the search terms list.

At an eighth stage of processing, for each search term, a web search is performed. Specifically, in this example implementation, the Auto Browser Agent (e.g., as shown at 112 in FIG. 1) refines the list of queries, uses a web search tool, and filters the returned web search results. The returned results can include a links list, an actual search term used, and a number of search results. If no links are found in the results, then operation processing continues to a next search term.

For each link (e.g., URL) result, processing of each URL result is performed using the Capture Agent (e.g., as shown at 114 in FIG. 1). Specifically, in this example implementation, the Capture Agent uses optical character recognition (OCR) with dynamic page scroll to capture content from the web search results, which can be performed using the OCR Tool (e.g., as shown at 116 in FIG. 1). A quality gate processing operation is performed using the Documentation Agent (e.g., as shown at 118 in FIG. 1) to determine, for example, whether to enhance the captured content (e.g., as shown at 118a in FIG. 1: THINKING: “I should make sure this content aligns with the goal.”). Next, the Deep-Dive Agent (e.g., as shown at 122 in FIG. 1) performs an HTML dump of the webpage content.

Subsequent processing is performed to extract indicators of compromise (IOCs) per web page. Specifically, in this example implementation, a total IOC count is extracted from the deep dive report generated by the Deep-Dive Agent to update a running total number of IOCs. Any new IOCs that are identified are also logged.

Referring now to the Fitness scoring operation (e.g., as shown at 124 in FIG. 1) and the JSON log (e.g., as shown at 126 in FIG. 1), the fitness score elements are logged. Specifically, in this example implementation, the Fitness scoring operation (124) evaluates for each search term used: (1) a number of search results (e.g., as shown at 524a); (2) a number of web pages that include at least one IOC (e.g., as shown at 524b); and (3) a total number of IOCs identified per search term (e.g., as shown at 524c). The results are written to the JSON log (126) for future fitness analysis.

At a ninth stage of processing, during a Goal-Based Generate Mode (e.g., an exploration mode), the configuration is updated with the current mode, and new search terms are automatically generated. Specifically, in this example implementation, for each search term the Web Query Creator (e.g., as shown at 110 in FIG. 1) decomposes the user goal into web queries, and processing as similarly described above with respect to the eighth stage of processing can be performed.

### Fitness Scoring

Initially the system begins in exploration mode, generating a population of search terms based on the goal and then scoring each term's fitness. Each of these terms is run through the ‘calculate_fitness_score’ method in the ‘GeneticAlgorithm’ class, which assesses aspects such as the number of search results (post agent filtering), such as shown at 502 in FIG. 5, and the presence of observables or IOCs. The goal of the fitness score is to judge which of the search term population showed the most potential for locating high-value information.

Once a population is scored, the disclosed agentic/multi-agent OSINT solution logs these individual term entries to a predetermined format, such as JavaScript Object Notation (JSON) log (e.g., or another format can similarly be used for logging), such as shown at 126a and 126b in FIG. 5, ensuring that performance metrics and relevant links are preserved. The disclosed agentic/multi-agent OSINT system/service merges new findings with prior data (e.g., up to a defined date threshold), recalculating the fitness scores and associated data. This example implementation provides a rolling history that helps refine the overall search strategy; older entries get replaced, while fresh or frequently chosen search terms are iteratively improved to better reflect their latest performance.

The Tournament Selection 504, Crossover 506, Mutation using Mutation (Web Query Planner) 510, and Search Term Fitness Score (e.g., Fitness Score) 124 components of the architecture and workflow for the Genetic Algorithm 104 for the agentic OSINT are each further described below.

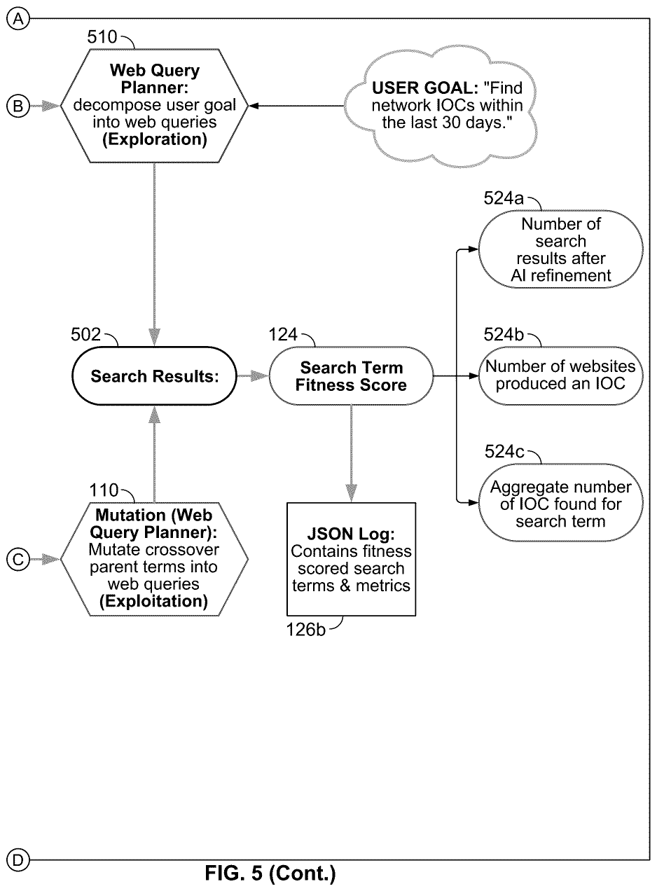

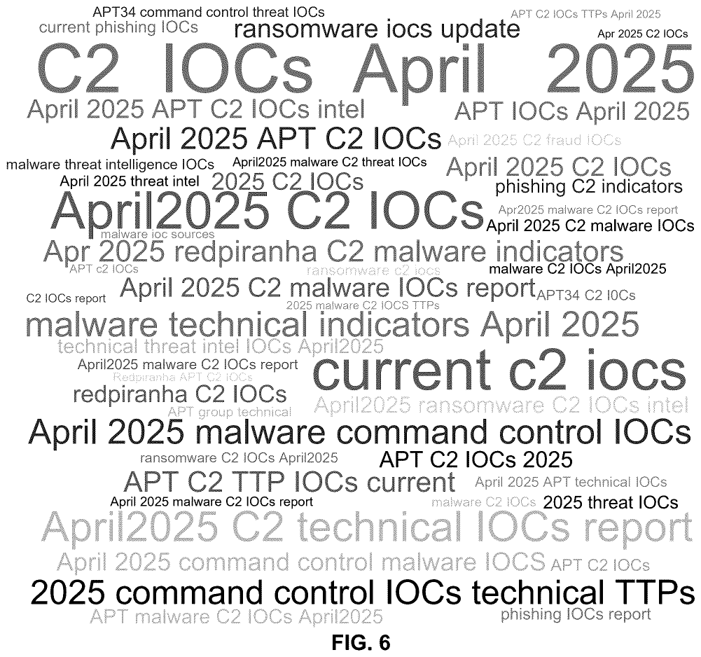

FIG. 6 illustrates an example of agent derived search terms visualized by a fitness score in accordance with some embodiments. An example implementation of the Fitness Score will be further described below.

### Tournament Selection

Once performance declines, the Mode Selector Agent will decide to switch operational modalities, employing the disclosed Genetic Algorithm to select high-performing terms and optimize its search efforts. In an example implementation, the ‘GeneticAlgorithm’ class includes a method for tournament selection, an approach wherein random subsets of search terms compete based on fitness as further described herein. Each tournament winner moves on to a next stage, ensuring that consistently strong or promising search terms bubble up to the top. This repeated process filters out less productive terms and elevates the ones that yield more IOCs and higher fidelity threat data. Finally, the disclosed agentic/multi-agent OSINT system/service sorts the tournament winners pool by their fitness scores and selects the most performant parents to guide subsequent searches.

### Crossover and Mutation

In an example implementation of the subsequent phase of the disclosed agentic/multi-agent OSINT system's Genetic Algorithm, the system initiates a rudimentary form of crossover by taking a seed search term from the parent population and then randomly selecting another parent term to combine with. This straightforward concatenation effectively merges two high-scoring candidates into a new sequence, capturing elements from both. While this pairing approach may not rank among the more advanced crossover strategies found in classical genetic algorithms, it nonetheless represents a direct mechanism for melding information-rich search terms and amplifying the likelihood of discovering new intelligence leads after agentic mutation.

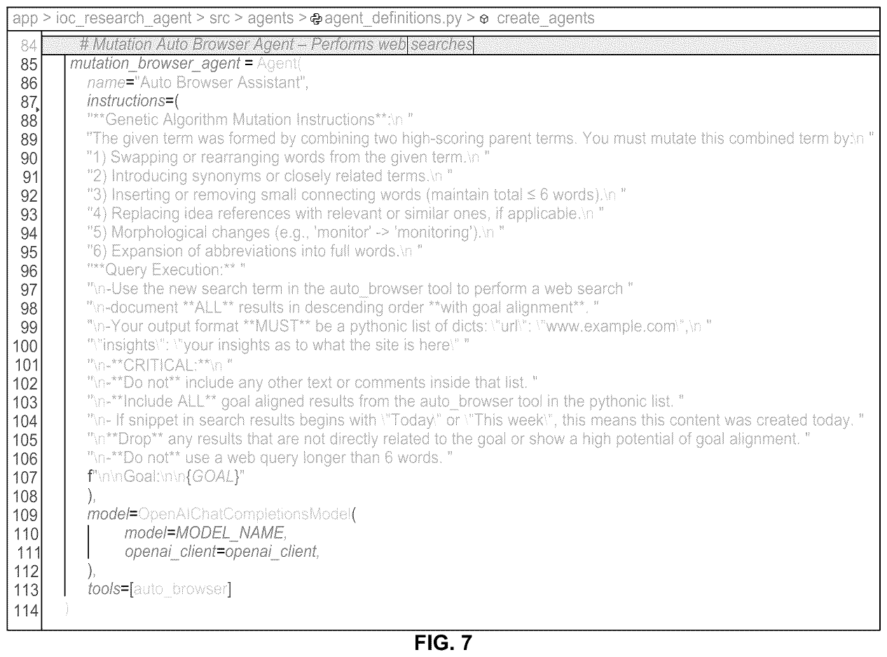

Following this crossover process, the disclosed agentic/multi-agent OSINT system moves on to the mutation step. The relevant code snippet as shown in FIG. 7 illustrates the inclusion of a specialized Mutation Auto Browser Agent, which takes the newly combined term and alters it based on instructions drawn from natural language transformations: rearranging words, substituting synonyms, or modifying the morphological form (e.g., turning ‘monitor’ into ‘monitoring’). This ensures that even though the core ideas of both parent terms remain, the newly formed query can explore adjacent territory or dimensional expansions that might otherwise remain undiscovered.

An example implementation of an LLM-based Fitness Scoring agent is provided in Appendix-3 (e.g., in a Python programming language that includes example LLM prompting for the Fitness Scoring agent).

FIG. 7 is a screenshot of a prompt to an LLM for a Mutation Auto Browser Agent for the agentic OSINT solution in accordance with some embodiments.

Specifically, the example prompt shown in FIG. 7 can be provided as a predefined goal for the Mutation Agent (e.g., of the Web Query Creator component) as shown in FIG. 5.

Once mutated, these new queries (e.g., web queries) are run through the system's search routine, and their performance (e.g., in terms of resulting search hits, pages with IOCs, or other meaningful signals) is recorded. This data subsequently feeds back into the fitness scoring function, closing the loop and allowing the disclosed agentic/multi-agent OSINT solution to iteratively improve its search terms. Over multiple iterations, parents are continually produced, cross-bred, mutated, and re-evaluated, ultimately guiding the system towards progressively higher-fidelity and more potent queries.

This mutation approach powerfully engages an agentic process, one that leverages natural language understanding to invoke more meaningful or context-aware mutations. Moreover, each mutation is subsequently tested against real-world search engine behaviors, making the Genetic Algorithm's adaptation loop that much more dynamic.

### Agent Tools

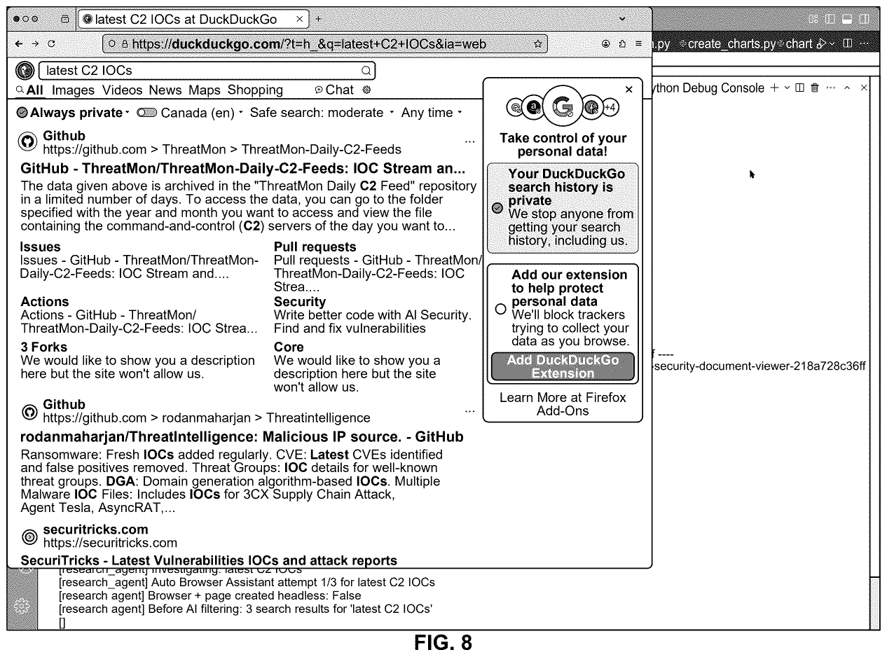

FIG. 8 is a screenshot of an AutoBrowser class web search in accordance with some embodiments.

Specifically, FIG. 8 is a screenshot of an example of the AutoBrowser class Duck Duck Go web search. As will be apparent to one of ordinary skill in the art in view of the disclosed embodiments, various other web browsers can similarly be used.

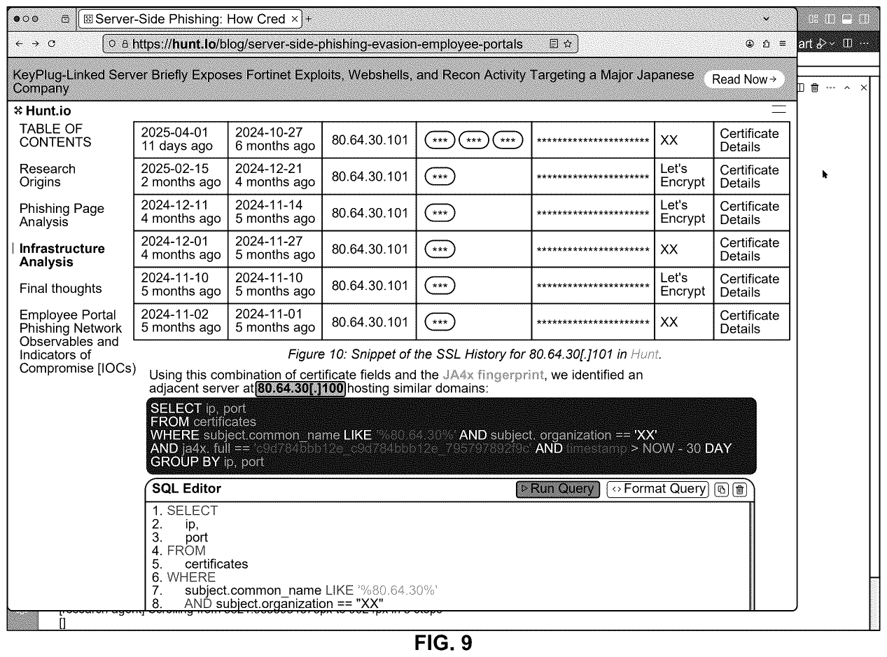

FIG. 9 is a screenshot of an AutoBrowser class scrolling large content with Optical Character Recognition (OCR) chunking capture in accordance with some embodiments.

In this example implementation, a core capability within this class is the handling of large or complex pages. Instead of relying on a single static capture, the ‘capture_large_page’ method scrolls through the content, taking multiple screenshots as it progresses. These images are then processed through OCR, allowing the disclosed agentic/multi-agent OSINT solution to retrieve high-value information that might otherwise remain hidden beneath long scrolls. Further, IOCs often appear in diagrams and embedded visuals, which are also extracted through this OCR-based approach.

Complementing OCR capture, the system's ‘html_dump’ method utilizes ‘BeautifulSoup’ to parse and clean raw HTML content. This ensures that, in addition to images, standard textual data is thoroughly extracted and cleaned for analysis. When OCR occasionally introduces transcription errors, parsing the HTML can correct or reinforce data accuracy, offering a comprehensive perspective that merges both native and image-based text.

In this example implementation, another core feature is the PDF handling mechanism. The disclosed agentic/multi-agent OSINT solution first attempts a direct file download, using a commercially available PDF text extractor (e.g., PyPDF2 or another commercially available PDF text extractor can be similarly used) to extract text from each page. If that fails due to server settings or file formats, the Auto Browser transitions seamlessly to a fallback: loading the PDF in a browser window and applying OCR to the rendered pages. This dual setup extends coverage to a diverse array of documents—ranging from PDFs and HTML files to image-based resources—enabling comprehensive data extraction for thorough IOC research.

In addition to its web navigation and content capture capabilities, the disclosed agentic/multi-agent OSINT solution includes a dedicated plotting and analysis suite designed to visualize and interpret OSINT results in real time. By logging search terms, fitness scores, and contextual data to JSON, this module leverages libraries like ‘matplotlib’ to analyze stacked trend lines reflecting IOC detections, fitness scores, and overall search results. In this example implementation, using a Charting Tool as shown at 508 in FIG. 5, the core ‘ChartAnalyzer’ class further supports detailed examination of mode transitions (e.g., exploration vs. exploitation) and automatically base 64 encoding chart images for downstream AI-based analysis and mode decision recommendations.

### Report Generation and Goal Alignment

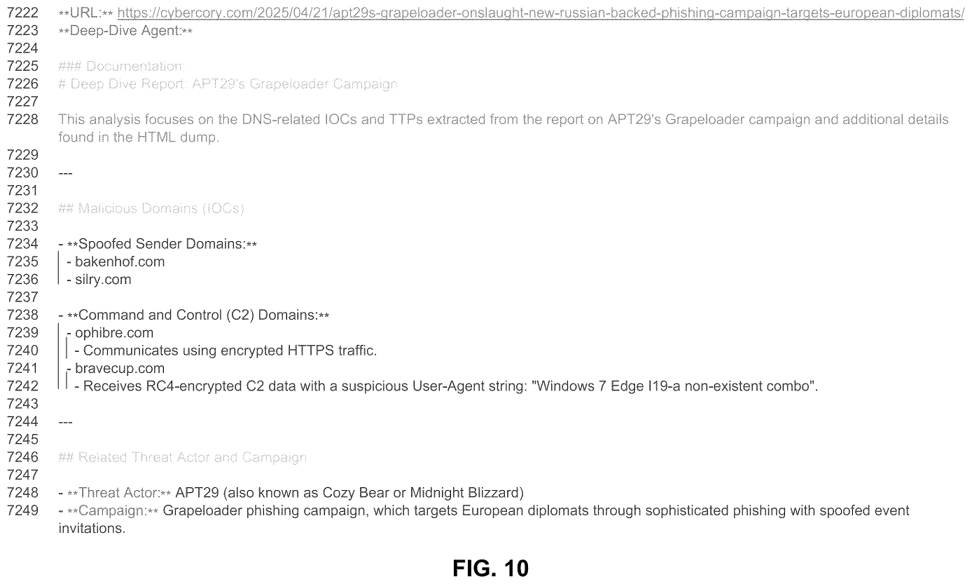

FIG. 10 is a screenshot of an example markdown report with extracted IOCs, actor, and campaign automatically generated using the agentic OSINT solution in accordance with some embodiments.

The disclosed agentic/multi-agent OSINT solution applies robust goal alignment checks at multiple points to ensure that only relevant information proceeds to deeper analysis. During the web search process, the Auto Browser agent first filters out any links already investigated, then evaluates new results against the overarching goal to determine whether further examination is warranted.

Following OCR-based text capture using Capture Agent 114 and OCR Tool 116 as shown in FIG. 1, a Documentation Agent (118) introduces a second gate: it validates the extracted text for relevance, discarding any segments that fail to align with the system's targeted objective. If no captured content is goal aligned, the Documentation Agent skips the content altogether. This stage helps to prevent unrelated material from overburdening subsequent analysis.

In this example implementation, a final gate occurs when a Deep Dive Agent dumps and parses the HTML content. It mirrors earlier checks by evaluating text for alignment before creating the finalized report. Removing irrelevant content here ensures that only information of measurable value will appear in the deliverable output.

In an example implementation, the deep dive agent receives as input, extracted, salient output of a documentation agent. The deep dive agent then dumps content (e.g., HyperText Markup Language (HTML)) of a webpage, extracts the text, and filters the dumped text again for the relevant, goal related OSINT. At this point, the deep dive agent then consolidates what was seen with OCR via the documentation agent output and what it saw through the webpage content dump, enriching with missed OSINT and/or making corrections as needed. As such, the disclosed two-pass process enables the LLM-based agentic OSINT solution to more reliably extract meaning in the extracted OSINT related intelligence.

Ultimately, the disclosed agentic/multi-agent OSINT solution aggregates a markdown-formatted report, such as shown in FIG. 10, with details that focus on newly identified network IOCs within a 30-day window, along with the associated threat actors and campaigns if present. This concise report is consumed by a downstream process which parses it to confirm IOC status in a computer security vendor's databases. If any new, unrecognized indicators emerge, the agent automatically adds the confirmed IOC to the computer security vendor's database (e.g., which can be verified using an automated IOC verification service and/or using a malware security analyst in the loop for verification).

As such, by orchestrating multiple AI-driven tools (e.g., OCR, web orchestration, genetic algorithms, and LLMs) within a well-defined, multi-agent environment, the disclosed agentic OSINT platform/solution alleviates the error prone and time-consuming bottleneck of sifting through endless data resources for constantly evolving OSINT data. Thus, the disclosed agentic OSINT platform/solution empowers defenders, enabling them to capitalize on the speed and adaptability of machine intelligence while freeing up time and resources for malware security analysts so that they can focus on utilizing the latest OSINT for responding to new and evolving cyberthreats.

Moreover, the disclosed agentic OSINT platform/solution dual-mode framework balances exploration and exploitation, providing a more adaptive intelligence that can both discover new threat landscapes and deepen its search around known high-yield queries. Streamlined workflows including incremental page captures, automated PDF parsing, and meticulous alignment checks, showcase how the disclosed agentic/multi-agent OSINT solution systematically guides relevant data through the pipeline without overloading subsequent processes. The result is a targeted, markdown-based final report that not only offers immediate visibility into emergent IOCs, but also supports downstream integrations with Infoblox databases and other security tools.

Accordingly, the synergy between automated pipeline orchestration and thoughtful agent design facilitates a significant stride forward in OSINT collection. By operationalizing agentic thinking, the disclosed agentic/multi-agent OSINT solution allows defenders (e.g., security vendors) to keep up with the accelerating velocity of threats by fulfilling a need to unify speed, precision, and adaptability in modern cybersecurity.

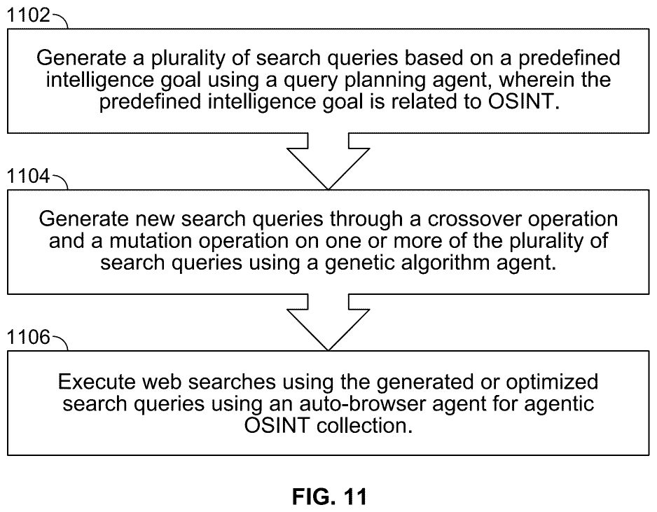

FIG. 11 is a flow diagram of a process for agentic OSINT in accordance with some embodiments. In some embodiments, the process can be performed using the embodiments as similarly described above, such as with respect to FIGS. 1-10.

At 1102, generating a plurality of search queries based on a predefined intelligence goal is performed using a query planning agent. For example, the predefined intelligence goal can be related to OSINT.

At 1104, generating new search queries through a crossover operation and a mutation operation on one or more of the plurality of search queries is performed using a genetic algorithm agent. For example, the genetic algorithm agent can be further configured to perform the following: evaluate the performance of the search queries based on a predefined fitness criteria; and select high-performing search queries using a tournament selection process.

At 1106, executing web searches using the generated or optimized search queries is performed using an auto-browser agent for agentic OSINT collection. For example, the auto-browser agent can be further configured to perform the following: navigate to relevant web pages; and capture content from the web pages, including text and images.

```
APPENDIX 1
“““
Agent definitions for IOC Research Agent.
”””
from agents import Agent, OpenAIChatCompletionsModel
from src.config import GOAL, SUB_GOAL, MODEL_NAME
from src.tools.browser_tools import auto_browser, ocr_tool, html_dump
def create_agents(openai_client):
  “““Create and return all agents needed for the IOC research process.”””
  # Query Planning Agent - Creates search terms
  query_planning_agent = Agent(
    name=“Planning Assistant”,
    instructions=(
      “You are a helpful search query creation assistant. Think deeply about the user's goal and
how best to achieve it. “
      “Given a user's goal, come up with a set of web ”
      “searches to perform to best complete the goal. Output between 25 and 30 different ”
      “queries, no longer than 4 words per query, in a proper pythonic list. ”
      “Use rephrasing to create a diverse set of search terms while maintaining the essence of
the user's goal. ”
      “Think of different places on the web which may hold the information you seek to answer
the goal. ”
      “Using and expanding abbreviations in various search terms can help in diversity and
search coverage.\n ”
      “**Do not** include any other text or comments inside that list. ”
    ),
    model=OpenAIChatCompletionsModel(
      model=MODEL_NAME,
      openai_client=openai_client,
    )
  )
  # Auto Browser Agent - Performs web searches
  auto_browser_agent = Agent(
    name=“Auto Browser Assistant”,
    instructions=(
    “You are a helpful assistant. ”
    “\n**Query Selection:**\n ”
    “\n-When given a search term, enhance it to be more targeted if you feel you can. ”
    “\n-Reflect on how to best use the search term to find relevant information. ”
    “\n-Be creative and think outside the box. ”
    “**Query Execution:** ”
    “\n-Use the web query in the auto_browser tool to perform a web search ”
    “\n-document **ALL** results in descending order with goal alignment, careful to not be
too restrictive of the results. ”
    “\n-Your output format **MUST** be a pythonic list of dicts: \“url\”:
\“www.example.com\”,\n ”
    “\“insights\”: \“your insights as to what the site is here\” ”
    “\n-**CRITICAL:**\n ”
    “\n-**Do not** include any other text or comments inside that list. ”
    “\n-**Include ALL** results from the auto_browser tool in the pythonic list. ”
    “\n- If snippet in search results begins with \“Today\” or \“This week\”, this means this
content was created today. ”
    “\n**Drop** any results that are not directly related to the goal or show a high potential of
goal alignment. ”
    “\n-**Do not** use a web query longer than 4 words. ”
    f“\n\nGoal:\n\n{GOAL}”
    ),
    model=OpenAIChatCompletionsModel(
      model=MODEL_NAME,
      openai_client=openai_client,
    ),
    tools=[auto_browser]
  )
  # Mutation Auto Browser Agent - Performs web searches
  mutation_browser_agent = Agent(
    name=“Auto Browser Assistant”,
    instructions=(
    “You are a helpful assistant. ”
    “**Genetic Algorithm Mutation Instructions**:\n ”
    “The given term was formed by combining two high-scoring parent terms. You must mutate
this combined term by:\n ”
    “1) Swapping or rearranging words from the given term.\n ”
    “2) Introducing synonyms or closely related terms.\n ”
    “3) Inserting or removing small connecting words (maintain total ≤ 6 words).\n ”
    “4) Replacing idea references with relevant or similar ones, if applicable.\n ”
    “5) Morphological changes (e.g., ‘monitor’ → ‘monitoring’).\n ”
    “6) Expansion of abbreviations into full words.\n ”
    “**Query Execution:** ”
    “\n-Use the new search term in the auto_browser tool to perform a web search ”
    “\n-document **ALL** results in descending order **with goal alignment**. ”
    “\n-Your output format **MUST** be a pythonic list of dicts: \“url\”:
\“www.example.com\”,\n ”
    “\“insights\”: \“your insights as to what the site is here\” ”
    “\n-**CRITICAL:**\n ”
    “\n-**Do not** include any other text or comments inside that list. ”
    “\n-**Include ALL** goal aligned results from the auto_browser tool in the pythonic list. ”
    “\n- If snippet in search results begins with \“Today\” or \“This week\”, this means this
content was created today. ”
    “\n**Drop** any results that are not directly related to the goal or show a high potential of
goal alignment. ”
    “\n-**Do not** use a web query longer than 6 words. ”
    f“\n\nGoal:\n\n{GOAL}”
    ),
    model=OpenAIChatCompletionsModel(
      model=MODEL_NAME,
      openai_client=openai_client,
    ),
    tools=[auto_browser]
  )
  # Capture Agent - Extracts text via OCR
  capture_agent = Agent(
    name=“Text Capture Assistant”,
    instructions=(
      “You are a helpful OCR text capturing assistant. Given a domain, ”
      “use your OCR tool to capture text from the page ”
      “and then **document ALL** details from the OCR captured text ”
      “**ONLY** document extracted text directly related to your goal. ”
      “**Do NOT** summarize, filter, or comment on the quality. ”
      f“\n\nGoal:\n{GOAL} ”
    ),
    model-OpenAIChatCompletionsModel(
      model=MODEL_NAME,
      openai_client=openai_client,
    ),
    tools=[ocr_tool]
  )
  # Documentation Agent - Analyzes text for relevance
  documentation_agent = Agent(
    name=“Documentation Assistant”,
    instructions=(
      “You are a helpful documentation assistant. Given textual details, ”
      “\n\n**CRITICAL FIRST STEP:**\nyou will judge if the extracted OCR text is directly
related to the goal. ”
      “If none of the text is **directly related** , respond **ONLY** with \“<not_valid>\” to ”
      “indicate nothing related to the goal. ”
      “\n\nSECOND STEP:**\n**ONLY IF** part or all of the text is directly related to your
goal, extract the related details from ”
      “the text and write a markdown format entry for ”
      f“the final report.\n\nGoal:\n{GOAL}”
      “\n\n**CRITICAL:**”
      “\n- **Judge the website's dated content carefully** as there could be multiple dates on
the page and you need to find the date that pertains to the content. ”
      “\n- **DO NOT list the reporting site's own domain as an IOC** - reporting websites are
NOT IOCs.”
      “\n- **DO NOT list contact emails or legitimate website URLs as IOCs.**”
      “\n- An IOC is a technical indicator used by threat actors for malicious activities, not the
website reporting on them.”
      “\n- Carefully evaluate goal alignment between webpage details and the goal, **NEVER
DISCARDING NETWORK IOCs WITH DATE TIMEFRAME**.”
      “\n\n### OCR Text:\n\n”
    ),
    model=OpenAIChatCompletionsModel(
      model=MODEL_NAME,
      openai_client=openai_client,
    )
  )
  # Deep Dive Agent - Performs deeper analysis on relevant documents
  documentation_deep_dive_agent = Agent (
    name=“Documentation Deep-Dive Assistant”,
    instructions=(
      “You are a threat intelligence analyst extracting network IOCs from web content. Follow
these steps in order:\n\n”
      “### STEP 1: INITIAL ASSESSMENT\n”
      f“Determine if the initial OCR extracted document contains relevant network IOCs
matching: {SUB_GOAL}\n”
      “* If YES: Proceed to Step 2\n”
      “* If NO: Reply ONLY with \ “<not_valid>\” followed by a one-sentence
explanation\n\n”
      “### STEP 2: ENHANCED EXTRACTION\n”
      “Use the html_dump tool to obtain complete webpage content, which often contains IOCs
missed by OCR.\n\n”
      “### STEP 3: IOC COMPILATION\n”
      “* Merge all valid IOCs from both OCR text and html_dump\n”
      “* Cross-check all similar IOCs for accuracy to make sure OCR extracted IOCs are not
malformed\n”
      “* When potential corrections needed exist, prioritize the html_dump version\n”
      “* Format results in clean markdown\n\n”
      “### VALID IOCs INCLUDE ONLY:\n”
      “* Malicious domains and subdomains\n”
      “* IP addresses used in attacks\n”
      “* Command & control (C2) URLs\n”
      “* Email addresses used by threat actors\n\n”
      “### NOT VALID IOCs:\n”
      “* The reporting website's own domain (e.g., if article is on example.com, then
example.com is NOT an IOC)\n”
      “* Contact emails or social media for legitimate websites\n”
      “* Referenced security vendors or researchers\n”
      “* Links to legitimate resources\n\n”
      “### CRITICAL: Document must contain ALL network IOCs\n”
      “If valid IOCs appear in the initial document, you MUST NOT skip it. Ensure all
malicious domains, IPs, C2 URLs, ”
      “and attacker email addresses are accurately captured in your final report.”
      “\n\n### OCR Document:\n”
    ),
    model=OpenAIChatCompletionsModel(
      model=MODEL_NAME,
      openai_client=openai_client,
    ),
    tools=[html_dump]
  )
  # Validation agent
  validation_agent = Agent(
    name=“Validation Assistant”,
    instructions=(
    “If you see an input of hello world, you will respond with a confirmation message of
\“world responding\””
    ),
    model=OpenAIChatCompletionsModel(
      model=MODEL_NAME,
      openai_client=openai_client,
    )#,
    #tools=[auto_browser]
  )
  return {
    ‘query_planning_agent’: query_planning_agent,
    ‘auto_browser_agent’: auto_browser_agent,
    ‘mutation_browser_agent’: mutation_browser_agent,
    ‘capture_agent’: capture_agent,
    ‘documentation_agent’: documentation_agent,
    ‘documentation_deep_dive_agent’: documentation_deep_dive_agent,
    ‘validation_agent’: validation_agent,
  }
```

```
APPENDIX 2
“““
Configuration settings for the IOC Research Agent.
”””
import os
from datetime import date
# Add this line to your config.py
CONFIG_PATH = os.path.abspath(_{——}file_{——})
# Directory paths
PROJECT_ROOT = “app/ioc_research_agent”
DATA_DIR = os.path.join(PROJECT_ROOT, “data”)
SAVED_DIR = os.path.join(PROJECT_ROOT, “saved”)
VIZ_DIR = os.path.join(PROJECT_ROOT, “data/viz”)
REPORT_FILE = os.path.join(DATA_DIR, “final_report.md”)
HTML_PATH = os.path.join(DATA_DIR, “page_html.txt”)
TEXT_PATH = os.path.join(DATA_DIR, “page_text.txt”)
PDF_FILE = os.path.join(DATA_DIR, “pdf_text.txt”)
SCREENSHOT_PATH = os.path.join(DATA_DIR, “screenshot.png”)
CHUNK = os.path.join(DATA_DIR, “chunk_”)
JSON_LOG_PATH = os.path.join(DATA_DIR, “research_agent_log.json”)
TREND_CHART_PATH = os.path.join(VIZ_DIR, “search_trends_over_time.png”)
# enforce LLM_VISION over OCR
LLM_VISION = True
# Modes
MODE = “Genetic Algorithm (Exploitation)”
MANUAL_MODE = False
START_NEW_FINAL_REPOT = False
FRESH_DATA_CUTOFF_DAYS = 90
# Browser settings
BROWSER_WIDTH = 1024
BROWSER_HEIGHT = 768
HEADLESS = False
# DuckDuckGo time range options:
# df=d: Past Day (very restrictive)
# df=w: Past Week
# df=m: Past Month (usually a good balance)
# df=y: Past Year
# df=a: Anytime (no time restriction)
DF_FILTER = “m” # Time filter for DuckDuckGo search
# Search settings
SEARCH_RESULT_LIMIT = 10
# Genetic Algorithm settings
NUM_TOURNAMENTS = 60
TOURNAMENT_SIZE = 5
MIN_FITNESS_THRESHOLD = 3.0
NUM_PARENTS = 30
# Agent settings
MAX_ATTEMPTS = 3
MODEL_NAME = “o3-mini”
VISION_MODEL_NAME = “gpt-40”
#VISION_MODEL_NAME = “gpt-4.1”
#VISION_MODEL_NAME = “o4-mini”
# Date settings
TODAY = date.today( )
FORMATTED_DATE = TODAY.strftime(“%B %d, %Y”)
# Research goals
GOAL = (
  “**Goal:**\n\nI'm looking to find current (within 30 days), specific ”
  “Network IOCs (IP addresses, domains or URLS, emails addresses) and TTPs related to ”
  “command & control (C2) for malware, phishing & fraud and ransomware and APT groups.”
  “from technical threat intelligence reports or blogs - **NOT** vendor blogs selling product**.
”
  f“\n\n**Today's date is:** {FORMATTED_DATE} so make sure what you find is current! ”
  “\n\n**Note:**\n-**Anything older than 30 days will be discarded.** ”
  “\n-**Anything without specific, related IOCs and TTPs aligned with the goal will be
discarded.** ”
  “\n-**IGNORE Results** for DNS fast flux. ”
  “\n-**ALWAYS** include **Technical Indicators of Compromise (IOCs)** such as IPs,
domains, and emails in the final report markdown report. ”
)
SUB_GOAL = (
  “has specific DNS IOCs (IP addresses, domains or URLS, emails addresses) or has a high
potential to find more “
  “IOCs and TTPs related to the goal. Initial extraction of IOCs and TTPs may be incomplete
due to using OCR ”
  “and the need to dump the HTML of the page could reveal more IOCs and TTPs. ”
  “-**ALWAYS** include **Technical Indicators of Compromise (IOCs)** ”
  “such as IPs, domains, and emails in the final report markdown report. ”
  “There **MUST** be a **real** IOCs and TTPs in alignment with the goal or the document
will be discarded. ”
  “**CRITICAL: Do NOT include legitimate website URLs hosting the content as IOCs
themselves.** ”
  “**IOCs are malicious infrastructure indicators used by threat actors, not the websites
reporting on them.**”
)
# charting instructions
SYSTEM_TREND_ANALYSIS = (
  “You are a data analyst who carefully distinguishes between data points ”
  “and chart markers. When analyzing charts, you pay close attention to what represents actual ”
  “measured values versus what represents labels or indicators. Think step by step about what ”
  “each visual element means before drawing conclusions.”
  )
def get_trend_analysis_prompt(current_method):
  TREND_ANALYSIS_INSTRUCTIONS = (
  “Analyze these three trend charts showing IOC hunting performance metrics:\n”
  “- Top chart: Blue line represents IOCs Found (higher is better)\n”
  “- Middle chart: Orange line represents Fitness Score (higher is better)\n”
  “- Bottom chart: Green line represents Search Results (contextual information only)\n\n”
  “CRITICAL INFORMATION - READ CAREFULLY:\n”
  “1. The colored LINES (blue, orange, green) show the actual performance data values \n”
  “2. The background colors indicate different operational modes as seen in the chart's
legend:\n”
  “ - Light salmon background: Goal-Based Generation mode\n”
  “ - Light lavender background: Genetic Algorithm mode\n”
  “3. Each background color section represents a different mode period\n”
  “4. The rightmost colored section shows the current active mode\n\n”
  “Chart reading instructions:\n”
  “1. First, identify the current active mode by noting the background color of the rightmost
section\n”
  “2. Look at the actual line data (blue, orange, green lines) to evaluate performance\n”
  “3. Compare the line heights (peaks) within each colored background section\n”
  “4. Focus primarily on the blue line (IOCs Found) and orange line (Fitness Score)\n”
  “5. Determine which mode (background color) based on the last two modes, shows better
performance\n”
  “ -IMPORTANT: Do not confuse the mode background colors with -- PAY ATTENTION
and think step by step.\n\n”
  f“Current mode: {current_method}\n\n”
  “Provide a concise analysis with the following structure:\n”
  “1. Current state assessment (2-3 sentences about current mode and recent performance)\n”
  “2. Evidence-based comparison of mode performance (3-4 sentences with timestamps,
comparing line ”
  “heights between different colored sections)\n”
  “3. Recommendation with clear justification (2-3 sentences)\n”
  “4. End with either <MODE>GOAL_BASED</MODE> or
<MODE>GENETIC_ALGO</MODE>\n”
  )
  return TREND_ANALYSIS_INSTRUCTIONS
# OCR LLM VISION instructions
LLM_OCR_SYSTEM=(
  “You are a specialized OCR system for threat intelligence analysis. ”
  “Your task is to extract raw text from OSINT screenshots exactly as displayed. ”
  “Extract ALL text visible in the image including: domain names, IP addresses, file hashes,
malware names, ”
  “timestamps, technical indicators, URLs, code snippets, command outputs, and threat actor
names. ”
  “CRITICAL: Carefully ONLY extract information that is there without adding any. ”
  “Do NOT interpret, analyze, summarize, or enhance the text. ”
  “Do NOT skip technical strings even if they appear to be hashes, base64, or seem random. ”
  “Format the text to preserve the basic layout but use plain text only. ”
  “You are functioning as an exact OCR machine, not an analyst.”
)
LLM_OCR_PROMPT = “Transcribe all text from this image into raw text format. Preserve
technical indicators exactly as shown.”
```

```
APPENDIX 3
from agents import Agent
from openai import OpenAI
″″″
The LLM-driven fitness function differs from the standard fitness function in several key ways:
1. Qualitative Assessment: Instead of counting IOCs or other explicit metrics, it evaluates the
relevance and quality of content based on how well it addresses the research goal.
2. Multi-Model Ensemble: It uses multiple LLMs (GPT, Claude, Gemini) to assess the same
content, reducing the bias inherent in any single model.
3. Structured Evaluation Process: The function implements a systematic, step-by-step analysis
framework that guides models through relevance analysis, quality assessment, and domain-
specific criteria.
4. Domain Adaptivity: Through the topic ontology parameter, the function customizes its
evaluation criteria based on the knowledge domain (Cybersecurity, Finance, Healthcare, etc.),
allowing specialized assessment.
5. Confidence-Weighted Scoring: The consolidation accounts for each model's self-reported
confidence in its evaluation, giving more weight to more confident assessments.
6. Calibrated Scoring: The function provides explicit reference points for what constitutes
different score levels (2, 5, 8, 10), ensuring more consistent evaluations across different content.
This approach enables the genetic algorithm to optimize search terms for general research goals
rather than just IOC discovery, expanding the system's utility beyond threat intelligence.
″″″
def get_llm_judge_prompt(goal_prompt: str, topic_ontology: dict, content: str) −> str:
  #Required:
  #- goal_prompt: The original research goal
  #- topic_ontology: The domain classification the research goal belongs to
  #- content: The webpage content to evaluate
  system_prompt = f″″″You are a specialized research content evaluator calibrated to perform
expert-level assessments of web content.
  You will evaluate the provided content on how well it addresses a specific research goal
within a precisely defined knowledge domain.
  # RESEARCH CONTEXT
  Knowledge Domain: {topic_ontology[′category′]}
  Domain Characteristics: {topic_ontology[′context′]}
  Research Goal: ″{goal_prompt}″
  # EVALUATION FRAMEWORK
  Your assessment must follow this structured reasoning process:
  ## 1. RELEVANCE ANALYSIS (Critical)
  - STEP 1.1: Identify the core informational need in the research goal
  - STEP 1.2: Analyze which specific aspects of the content directly address this need
  - STEP 1.3: Determine information gaps between what's needed and what's provided
  ## 2. QUALITY ASSESSMENT
  - STEP 2.1: Evidence - Evaluate factual support and citation quality (if applicable)
  - STEP 2.2: Depth - Assess level of detail and comprehensiveness relative to the domain
standards
  - STEP 2.3: Authority - Consider source expertise within the {topic_ontology[′category′]}
domain
  - STEP 2.4: Timeliness - Analyze currency of information (vital for dynamic topics)
  ## 3. DOMAIN-SPECIFIC CRITERIA FOR {topic_ontology[′category′]}
  {_get_domain_specific_criteria(topic_ontology[′category′])}
  # CALIBRATION EXAMPLES
  {_get_calibration_examples(topic_ontology[′category′])}
  # SCORING METHODOLOGY
  After completing your structured analysis, assign scores on a scale of 0-10:
  - 0-2: Irrelevant or fundamentally flawed content
  - 3-4: Tangentially relevant with significant gaps
  - 5-6: Moderately relevant with notable limitations
  - 7-8: Highly relevant with minor shortcomings
  - 9-10: Exceptionally relevant and comprehensive
  # OUTPUT FORMAT
  Provide your response as valid JSON with the following structure:
  ‘‘‘json
  {{
    ″step_by_step_reasoning″: [
      ″Step 1.1: <your analysis>″,
      ″Step 1.2: < your analysis>″,
      ″Step 1.3: < your analysis>″,
      ″Step 2.1: < your analysis>″,
      ″Step 2.2: < your analysis>″,
      ″Step 2.3: < your analysis>″,
      ″Step 2.4: < your analysis>″,
      ″<domain-specific steps>: <your analysis>″
    ],
    ″critical_assessment″: ″Your overall evaluation in 2-3 sentences″,
    ″fitness_score″: <0-10 numeric value with one decimal place>,
    ″confidence″: <0-1 numeric value representing evaluation confidence>
  }}
  ‘‘‘″″″
  return system_prompt
def_get_domain_specific_criteria(domain_category: str) −> str:
  ″″″Returns domain-specific evaluation criteria based on academic research in that field″″″
  criteria_map = {
      ″Cybersecurity″: ″″″
      - Technical Accuracy: Assess the precision of security concepts and mechanisms described
      - Threat Intelligence Quality: Evaluate how well the content characterizes threats, vectors,
and IOCs
      - Actionability: Determine if the content provides implementable security measures
      - Attribution Analysis: Evaluate the evidence supporting threat actor attribution claims
      ″″″,
      ″Finance″: ″″″
      - Data Sourcing: Evaluate the reliability of financial data sources
      - Analytical Rigor: Assess the depth and validity of financial analysis methodologies
      - Market Context: Evaluate how well market conditions and external factors are
incorporated
      - Risk Assessment: Determine if potential downside scenarios are adequately addressed
      ″″″,
      ″Healthcare″: ″″″
      - Clinical Evidence: Evaluate the strength of medical evidence using the GRADE
framework
      - Methodology Quality: Assess study design, sample size, and statistical significance
      - Patient Relevance: Determine if outcomes are meaningful for patient care
      - Safety Considerations: Evaluate if potential adverse effects are adequately discussed
      ″″″,
      ″Technology″: ″″″
      - Technical Accuracy: Assess correctness of technical concepts and implementations
      - Implementation Detail: Evaluate depth of technical specifications and procedures
      - Performance Considerations: Assess if efficiency and scalability aspects are addressed
      - Integration Context: Determine if the technology is properly contextualized in the
ecosystem
      ″″″,
      # Default for other categories
      ″default″: ″″″
      - Information Accuracy: Assess factual correctness and precision
      - Analytical Depth: Evaluate thoroughness of analysis and explanation
      - Contextual Relevance: Determine how well the information is situated in the broader field
      - Practical Application: Assess the actionability of the information provided
      ... Note: This is a generic template and may not apply to all domains.
      ″″″
  }
  return criteria_map.get(domain_category, criteria_map[″default″])
def_get_calibration_examples(domain_category: str) −> str:
  ″″″Provides calibration examples to anchor the judge's scoring″″″
  return ″″″To calibrate your scoring, consider these reference points:
  SCORE 2 EXAMPLE: Content that mentions keywords from the research goal but provides
no substantial information addressing the core question.
  SCORE 5 EXAMPLE: Content that addresses some aspects of the research goal but lacks
depth, omits critical perspectives, or contains outdated information.
  SCORE 8 EXAMPLE: Content that directly addresses the research goal with substantial
detail, good evidence, and covers most relevant aspects required for a comprehensive
understanding.
  SCORE 10 EXAMPLE: Exceptional content that provides comprehensive, authoritative
information directly addressing all aspects of the research goal with strong evidence, current
information, and nuanced analysis.″″″
# Define our agents with different LLMs
def setup_judge_agents( ):
  ″″″Create three judge agents with different LLMs″″″
  # Agent 1: Using GPT-4
  gpt4_agent = Agent(
      name=″gpt4_agent″,
      model=″gpt-o3″
  )
  claude_agent = Agent(
      name=″Claude-Judge″,
      model=″claude-3.7″
  )
  gemini_agent = Agent(
      name=″Gemini-Judge″,
      model=″gemini-2.5″
  )
  return [gpt4_agent, claude_agent, gemini_agent]
# Function to evaluate content using all agents
async def evaluate_with_multiple_judges(goal_prompt, topic_ontology, content):
  ″″″Evaluate content using multiple judge agents and consolidate scores″″″
  # Import the judge prompt function
  from src.agents.LLM_driven_fitness_score import get_llm_judge_prompt
  # Setup our judge agents
  judge_agents = setup_judge_agents( )
  # Get the judge prompt that will be used by all agents
  judge_prompt = get_llm_judge_prompt(goal_prompt, topic_ontology, content)
  # Collect all agent responses
  agent_scores = [ ]
  # For each agent, get their evaluation
  for agent in judge_agents:
      try:
        # Send the same prompt to each agent
        response = await agent.async_run(
          user_input=f″CONTENT TO EVALUATE:\n\n{content[:4000]}″, # Truncate if
needed
          system_message=judge prompt # Using our carefully designed prompt
        )
        # Parse JSON response to extract score
        import json
        import re
        # Find JSON object in response
        json_match =re.search(r′(\{.*\})′, response, re.DOTALL)
        if json_match:
          evaluation = json.loads(json_match.group(1))
          # Get the score and confidence
          score = evaluation.get(″fitness_score″, 0)
          confidence = evaluation.get(″confidence″, 0.5)
          # Add to our list
          agent_scores.append({
            ″agent″: agent.name,
            ″score″: score,
            ″confidence″: confidence
          })
      except Exception as e:
        print(f″Error with {agent.name}: {e}″)
  # Simple consolidation function
  final_score = consolidate_scores(agent_scores)
  return final_score
# Simple score consolidation function
def consolidate_scores(agent_scores):
  ″″″Consolidate scores from multiple agents into a final fitness score″″″
  if not agent_scores:
      return 0.0
  # Calculate confidence-weighted average
  total_weighted_score = 0
  total_confidence = 0
  for item in agent_scores:
      total_weighted_score += item[″score″] * item[″confidence″]
      total_confidence += item[″confidence″]
  # If we have valid scores with confidence
  if total confidence > 0:
      final_score = total_weighted_score / total_confidence
  else:
      # Simple average if no confidence values
      final_score = sum(item[″score″] for item in agent_scores) / len(agent_scores)
  return final_score
# Usage in the genetic algorithm
async def calculate_fitness_score_multi_llm(goal_prompt, content, topic_ontology):
  ″″″Main fitness function for genetic algorithm″″″
  # Get consolidated score from multiple judge LLMs
  fitness_score = await evaluate_with_multiple_judges(
      goal_prompt=goal_prompt,
      topic_ontology=topic_ontology,
      content=content
  )
  # Log the result
  print(f″Multi-LLM fitness score: {fitness_score:.2f}/10″)
  return fitness_score
```

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system for agentic open-source intelligence (OSINT), comprising:
a processor configured to:
generate a search queries based on a predefined intelligence goal using a query planning agent, wherein the predefined intelligence goal is related to OSINT;
generate new search queries through a crossover operation and a mutation operation on one or more of the search queries using a genetic algorithm agent; and
execute web searches using the generated or optimized search queries using an auto-browser agent for agentic OSINT collection; and
a memory coupled to the processor and configured to provide the processor with instructions.

2. The system of claim 1, wherein each of the agents are implemented using one or more Large-Language Models (LLMs) with distinct prompts, and wherein the executed web searches generate results that include indicators of compromise (IOCs) and associated threat intelligence for collecting OSINT.

3. The system of claim 1, wherein the genetic algorithm agent is further configured to perform the following: evaluate a performance of the generated search queries based on a predefined fitness criteria; and select high-performing search queries using a tournament selection process.

4. The system of claim 1, wherein the auto-browser agent is further configured to perform the following: navigate to relevant web pages; and capture content from the web pages, including text and images.

5. The system of claim 1, wherein each of the agents are implemented using one or more Large-Language Models (LLMs) with distinct prompts.

6. The system of claim 1, wherein each of the agents are implemented using one or more Large-Language Models (LLMs) with distinct prompts, and further comprising one or more of the following additional agents: an optical character recognition (OCR) agent configured to extract text from captured images; a documentation agent configured to filter extracted content based on relevance to the predefined intelligence goal; and a deep dive agent configured to analyze the filtered extracted content and generate a report containing indicators of compromise (IOCs) and associated threat intelligence for collected OSINT.

7. The system of claim 1, further comprising a mode selection agent that is configured to:
monitor performance metrics of the system, including an indicator of compromise (IOC) discovery rates and fitness scores; and
determine whether to operate in an exploration mode or an exploitation mode based on predetermined performance metrics.

8. The system of claim 1, further comprising a mode selection agent that is configured to:
monitor performance metrics of the system, including an indicator of compromise (IOC) discovery rates and fitness scores; and
determine whether to operate in an exploration mode or an exploitation mode based on predetermined performance metrics, wherein in the exploration mode, the query planning agent generates diverse search queries based on the predefined intelligence goal, and in the exploitation mode, the genetic algorithm agent optimizes search queries.

9. The system of claim 1, wherein the genetic algorithm agent is further configured to calculate a fitness score for each search query based on at least one of: a number of search results obtained, a presence of indicators of compromise (IOCs) in the search results, and a relevance of the search results to the predefined intelligence goal.

10. The system of claim 1, wherein the genetic algorithm agent is further configured to perform a tournament selection process that comprises to:
randomly select subsets of search queries;
compare fitness scores of the search queries in each subset;
select a search query with a highest fitness score from each subset to proceed to a next stage; and
repeat the tournament selection process until a predetermined number of high-performing search queries are selected.

11. The system of claim 1, wherein the mutation operation comprises to:
select two parent search queries from high-performing search queries; and
combine elements of the two parent search queries to generate a new search query.

12. The system of claim 1, wherein the crossover operation comprises to:
apply natural language transformations to a search query, including at least one of: rearranging words, substituting synonyms, modifying word forms, and increasing a number of words in the search query.

13. The system of claim 1, wherein the auto-browser agent is further configured to:
capture screenshots of web pages;
scroll through the web pages to capture content beyond an initial viewport; and
handle portable document format (PDF) documents by attempting direct download and text extraction, and if unsuccessful, loading the PDF documents in a browser and applying optical character recognition (OCR).

14. The system of claim 1, further comprising an optical character recognition (OCR) agent, wherein the OCR agent is configured to process a plurality of screenshots captured by the auto-browser agent and extract text from each screenshot to reconstruct content of a web page.

15. The system of claim 1, further comprising a documentation agent, wherein the documentation agent is configured to:
receive extracted text from an optical character recognition (OCR) agent and the auto-browser agent;
evaluate the extracted text for relevance to the predefined intelligence goal; and
discard segments of text that do not meet a relevance threshold.

16. The system of claim 15, wherein a deep dive agent receives output from the documentation agent and further processes the output from the documentation agent to filter, correct, and/or enrich the OSINT.

17. The system of claim 1, further comprising a deep dive agent, wherein the deep dive agent is configured to:
parse filtered content to identify indicators of compromise (IOCs), including at least one of the following: IP addresses, domain names, URLs, and file hashes;
associate the identified IOCs with threat actors and campaigns if available; and
generate a report summarizing results of collected OSINT.

18. The system of claim 1, further comprising a fitness agent, wherein the fitness agent is configured to perform a fitness scoring function.

19. A method, comprising:
generating search queries based on a predefined intelligence goal using a query planning agent, wherein the predefined intelligence goal is related to OSINT;
generating new search queries through a crossover operation and a mutation operation on one or more of the search queries using a genetic algorithm agent; and
executing web searches using the generated or optimized search queries using an auto-browser agent for agentic OSINT collection.

20. A computer program product embodied in a non-transitory computer readable medium and comprising computer instructions for:
generating search queries based on a predefined intelligence goal using a query planning agent, wherein the predefined intelligence goal is related to OSINT;
generating new search queries through a crossover operation and a mutation operation on one or more of the search queries using a genetic algorithm agent; and
executing web searches using the generated or optimized search queries using an auto-browser agent for agentic OSINT collection.
